(19) United States
(12) Patent Application Publication
(10) Pub. No.: US 2010/0315323 A1
(43) Pub. Date: Dec. 16, 2010

(54) BACKLIGHT SYSTEM

(75) Inventors: Giovanni Cennini, Eindhoven (NL); Fetze Pijlman, Eindhoven (NL); Hugo Johan Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDOHOVEN (NL)

(21) Appl. No.: 12/446,261

(22) PCT Filed: Oct. 17, 2007
(86) PCT No.: PCT/IB2007/054220

§ 371 Date: Apr. 20, 2009

(30) Foreign Application Priority Data
Oct. 23, 2006 (EP) 06122752.6

(51) Int. Cl. G09G 3/36

(52) U.S. Cl. 345/102

(57) ABSTRACT

An adaptively controllable backlight system (1), having a plurality of individually controllable light-sources (3a-d) arranged on a backlight panel (2) to emit light in a direction substantially normal to the backlight panel (2). The backlight system (1) further comprises an outcoupling plate (5) arranged adjacent to the backlight panel (2), and adapted to capture a fraction of the light emitted by the light-sources (3a-d) and to outcouple the fraction of light through at least one outcoupling-surface (8a-b) of the outcoupling plate (5), and at least one light-guide (9, 10) arranged to receive the outcoupled light and adapted to guide the outcoupled light towards at least one outcoupling-surface (14a-b, 15a-b) of the light-guide (9, 10). Additionally, at least one sensor (16-19) is arranged to receive the guided outcoupled light and adapted to provide a signal indicative of at least one property of the outcoupled light, thereby enabling adaptive control of the backlight system (1).

### TECHNICAL FIELD

The present invention relates to an adaptively controllable backlight system, and a display device comprising such a backlight system.

### TECHNICAL BACKGROUND

Today, various types of flat-panel displays are used in a wide variety of applications, from mobile phone displays to large screen television sets. While some kinds of flat panel displays, such as so-called plasma displays, are comprised of arrays of light emitting pixels, the majority of flat-panel displays have arrays of pixels, which can be switched between states but are unable to independently emit light. Such flat-panel displays include the ubiquitously found LCD-displays. In order for such flat-panel displays to be able to display an image to a user, the pixel array must be illuminated by either a so-called backlight, in the case of a trans-missive type pixel array, or, in the case of a reflective type pixel array, by ambient light or a so-called front-light.

A conventional backlight is comprised of a planar light-guide into which light is coupled from a light-source. One face of the planar light-guide is typically modified through structuring or modification, for example, surface roughening, to enable outcoupling of light through that face. The outcoupled light then passes through pixels in the pixel array, which are in a trans-missive state, and a corresponding image becomes visible to a viewer.

When, however, as is often the case, only a very small proportion of the pixels are bright (in their trans-missive state), a correspondingly large fraction of the light emitted by the backlight is prevented from reaching the viewer and precious energy thus wasted.

By providing the backlight as a backlight panel having a plurality of individually controllable light-sources, on the other hand, the backlight can be locally dimmed, which results both in an enhancement of image contrast and in a reduction of power consumption.

However, the light-sources comprised in the backlight may exhibit a substantial spread of their luminous intensities at the same operating conditions. Furthermore, aging of the light-sources may result in a progressive degradation of the performance of the backlight and, consequently, the display device comprising the backlight.

US 2003/0043107 discloses a liquid crystal display (LCD) system having a LED-backlight system in which backlight luminance sensing is realized by providing a number of representative LEDs together with a photo-detector on the backside of the backlight panel.

With the sensing system according to US 2003/0043107 representative “sampling” LEDs are monitored rather than the LEDs that are actually contributing to the emitted backlight. Consequently, individual variations among the emitting LEDs cannot be monitored and, accordingly, not compensated for.

There is thus a need for an improved backlight system enabling monitoring and calibration of the light sources contributing to the emitted backlight.

### OBJECTS OF THE INVENTION

In view of the above-mentioned and other drawbacks of the prior art, a general object of the present invention is to provide an improved backlight system.

### SUMMARY OF THE INVENTION

According to the present invention, these and other objects are achieved through an adaptively controllable backlight system, comprising a plurality of individually controllable light-sources arranged on a backlight panel to emit light in a direction substantially normal to the backlight panel; an outcoupling plate arranged adjacent to the backlight panel, and adapted to capture a fraction of the light emitted by the light-sources and to outcouple the fraction of light through at least one end-surface of the outcoupling plate; at least one light-guide arranged to receive the outcoupled light and adapted to guide the outcoupled light towards at least one end-surface of the light-guide; and at least one sensor arranged to receive the guided outcoupled light and adapted to provide a signal indicative of at least one property of the outcoupled light, thereby enabling adaptive control of the backlight system.

The individually controllable light-sources may be any kind of light-sources suitable for use in backlight systems, such as, for example, semiconductor-based light sources, including light-emitting diodes (LEDs) and semiconductor lasers, organic light emitting diodes (OLEDs), or fluorescent light-sources.

By “backlight panel” should, in the context of the present application, be understood a panel which is adapted to support a plurality of light-sources. The backlight panel may be rigid or flexible, and it may or may not contain wiring for supplying power to the light-sources. The backlight panel may advantageously be formed as a circuit board, which may be rigid (so-called PCB) or flexible (so-called FPC).

The “outcoupling plate” is a plate, which is adapted to transmit substantially all the visible light emitted by the light-sources, and to outcouple a small fraction of the emitted light through one or several outcoupling surface(s) of the outcoupling plate. The outcoupling plate may be provided in the form of a planar optical waveguide, which may, for example, be made of a slab of a single dielectric material or combinations of dielectric materials. Suitable dielectric materials include different transparent materials, such as various types of glass, poly-methyl methacrylate (PMMA), poly-carbonate (PC) etc. Such a planar waveguide may be flat or have a curved appearance. A slab-type planar waveguide typically relies upon total internal reflection (TIR) in order to contain light coupled into the waveguide.

The outcoupling plate may, furthermore, be rigid or flexible. Preferably, a rigid outcoupling plate is used in conjunction with a rigid backlight panel and vice versa.

The sensor may be capable of sensing any property of visible or invisible radiation or combinations of such properties. Properties, which may be sensed, include for example, wavelength distribution, luminous intensity, polarization, color co-ordinates, chroma, and saturation.

Through the backlight system according to the present invention, the properties of light emitted by every one of the individually controllable light sources can be sensed and the backlight system controlled accordingly. Hereby, initial variation can be compensated for at the production stage, and gradually occurring variations and drifts can be dealt with during the lifetime of the product in which the backlight according to the invention is incorporated.

Furthermore, since outcoupled light is collected and guided by the light guides towards a sensor, only one or a few sensors are required to sample the light emitted by every one of the individually controllable light-sources.

It should, in this context, be noted that the document WO 2004/023443 discloses an OLED-display, which is equipped with an optical feedback system for enabling calibration and correction of individual pixels in the display. In this optical feedback system, a sheet waveguide is used to couple light emitted by the OLEDs in the display to a photosensor connected to the sheet waveguide. There would be no reason for the skilled person to try to adapt the OLED-display disclosed in WO 2004/023443 to function as a backlight. Furthermore, light-guides for guiding light outcoupled by the sheet waveguide are not disclosed. It is suggested, however, that the sheet waveguide could be segmented into rows or columns, which each guide light to a sensor connected thereto.

In the backlight system according to the present invention, structures may advantageously be formed on a surface of the outcoupling plate facing away from the backlight panel, an average width of the structures being substantially smaller than an average distance between the structures, to thereby ensure that only a suitably small fraction of the emitted light is captured by the outcoupling plate.

For example, a ratio between the average width of the structures and the average distance between the structures may be smaller than 1/6.

These structures may be provided as linear structures, which may or may not be parallel, and/or point-structures, such as spherical or pyramidical indentations or projections. The linear structures and/or point-structures may advantageously be oriented with respect to an outline of the outcoupling plate, such as, for example, parallel to an outcoupling surface.

In general, a depth of the structures may preferably be in the same order of magnitude as the width of the structures.

Furthermore, the structures may be prismatic grooves, which may, for example, be engraved on the top surface of the outcoupling plate. Such prismatic grooves may advantageously have a depth, which is around half the width of the grooves.

Through the provision of these structures, it is ensured that only a very small fraction of the emitted light is captured by the outcoupling plate and, consequently, prevented from contributing to the backlighting of an image forming panel, such as an LCD-panel.

According to one embodiment of the backlight system according to the present invention, the average distance between the structures is smaller on first surface portions of the outcoupling plate corresponding to positions of the light-sources, than on second surface portions of the outcoupling plate corresponding to spaces between the light-sources.

The structures for outcoupling may thus be provided more densely where their outcoupling efficiency is the greatest, that is, on surface portions corresponding to the positions of the light-sources on the backlight panel. On surface portions corresponding to areas of the backlight panel between the light-sources, the outcoupling structures may be provided considerably less densely, or is even left out completely.

In this way it is ensured that a sufficiently large fraction of the light emitted by each light-source can be captured and outcoupled towards the at least one outcoupling surface of the outcoupling plate, while the normal operation of the backlight system is disturbed as little as possible by the structures provided on the outcoupling plate.

Furthermore, the structure configuration according to the present embodiment enables spreading of the light transmitted through the outcoupling plate, which leads to an increased uniformity of the light emitted by the backlight system. This is especially desirable for implementations in which there is a large distance (in the order of centimeters) between the light-sources. In order to achieve an efficient spreading of the light transmitted through the outcoupling plate, while at the same time capturing and outcoupling a suitably small fraction of the emitted light, a density of structures on surface portions corresponding to the positions of the light-sources on the backlight panel may be very high, such as 90% or higher. Furthermore, spreading structures for permitting some of the light captured by the densely provided structures to escape through the surface of the outcoupling plate facing away from the backlight panel may be provided on surface portions corresponding to areas of the backlight panel between the light-sources. These spreading structures may advantageously be designed to permit all of the light except for a fraction sufficient for reliable detection by the sensor(s) to escape from the outcoupling plate through its surface facing away from the backlight panel. To this end, the spreading structures may be similar to or different from the densely provided structures.

Advantageously, the average distance between the structures is equal for all of the first surface portions.

Hereby, it is ensured that essentially the same fraction of light from each of the light-sources is captured and outcoupled by the outcoupling plate. At the same time, the efficiency of the backlight system during normal operation is disturbed as little as possible.

According to another embodiment of the present invention, the structures may be periodically provided and have a ratio between the size and a period pitch which is smaller than 1/6.

In particular, the size of the microstructures may, for example, be 10 to 500 micron, and preferably 10 to 50 micron, and the pitch may, for example, be 0.3 to 5 mm. The smaller the size of the structures and the larger the pitch, the smaller the fraction of captured/outcoupled light becomes.

The outcoupling plate may be adapted to outcouple light through two opposing outcoupling-surfaces.

Hereby, light from all the light-sources in the backlight system can be averaged with respect to position in a light-source matrix by adding the light outcoupled through the opposing outcoupling surfaces.

Furthermore, a corresponding one of the light-guides may be positioned adjacent to each of the outcoupling-surfaces.

In this way, all the light that is outcoupled through the outcoupling surfaces of the outcoupling plate is captured by the light-guides and directed towards the sensor(s). Hereby, practically all of the outcoupled light reaches the sensor(s) and can thus be used for calibration of the light-sources comprised in the backlight system.

According to a further embodiment of the present invention, the at least one sensor may be provided to receive guided light emitted through each of the light-guide outcoupling-surfaces.

By adding the signals provided by sensors adapted to sense corresponding properties of the light emitted through each of the light-guide outcoupling faces, an averaging with respect to light-source position is achieved. In other words, the same fraction of the light emitted by a light-source may be received by the sensors independently of the position of the light-source on the backlight panel. Thereby, a more accurate and reliable control of the backlight is enabled.

In some applications, a further calibration may be needed to fully compensate for the different positions of the light-sources. In such a calibration, which could, for example, take place at the factory, each light-source may be sequentially switched on, and the signals provided by each of the sensors and the light distribution from the backlight measured. Based on these measurements, the system can be calibrated to provide a correct output independently of light-source position.

According to yet another embodiment, the backlight system may further comprise at least one mirror arranged to direct light emitted through a corresponding light-guide outcoupling-surface to the at least one sensor.

Through this provision of one or several suitably arranged mirror(s) practically all of the outcoupled light can be directed towards a single sensor. Hereby, manufacturing cost may be reduced as well as measurement errors resulting from differences between individual sensors eliminated.

The backlight system according to the present invention may further advantageously comprise control circuitry adapted to receive the signal provided by the at least one sensor, and to control the light-sources based on the received signal.

Moreover, the backlight system according to the present invention may further comprise a light-spreading plate for spreading light emitted by the light-sources, thereby increasing uniformity of light emitted by the backlight system.

The number of light-sources needed to realize a panel-type backlight system mainly depends upon the output power of the light-sources comprised in the backlight system. The higher the output power of the light-sources is, the fewer light-sources are needed to produce the necessary amount of light. Obviously, the provision of few high-power light-sources leads to a larger distance between light-sources for a given backlight panel size, which in turn leads to a decreased uniformity of the light emitted by the backlight-panel.

This uniformity can be improved by including a light-spreading plate in the backlight system according to the present invention.

Furthermore, this light-spreading plate may be formed by the outcoupling plate.

For example by providing a suitable structure configuration on the outcoupling plate, an increased uniformity of the light transmitted through the outcoupling plate may be achieved while, at the same time, capturing and outcoupling through the at least one outcoupling surface a suitably small fraction of the light emitted by the light-sources.

An example of such a suitable surface configuration may be to provide structures very densely, such as occupying 90% or more of the surface area, on portions of the outcoupling plate corresponding to positions of light-sources on the backlight panel, and spreading structures for permitting some of the light captured by the densely provided structures to escape through the surface of the outcoupling plate facing away from the backlight panel on portions of the outcoupling plate corresponding to areas of the backlight panel between the light-sources. These spreading structures may advantageously be designed to permit all of the light except for a fraction sufficient for reliable detection by the sensor(s) to escape from the outcoupling plate through its surface facing away from the backlight panel. To this end, the spreading structures may be similar to or different from the densely provided structures.

Additionally, the backlight system according to the present invention may further comprise a light-modifying member adapted to modify at least one property of outcoupled light interacting with the light-modifying member.

The light-modifying member may be any element capable of modifying any property of light, including, for example, wavelength range, spectral separation, polarization state and direction. Examples of such light-modifying members thus include, for example, prisms, diffraction gratings, filters, polarizers, lenses and mirrors.

Through the addition of such a light-modifying member, the number of useable sensors is increased. For example, in case the light-sources on the backlight panel are compound light-sources which each are comprised of a number of differently colored mono-color light-sources, the light emitted by these mono-color light sources may, separately from each other, be sensed simultaneously by separating the mixed light emitted by the compound light-source into differently colored mono-color components corresponding to the mono-color light-sources. Each of the differently colored mono-color components can then be sent to a corresponding sensor, directly or via mirrors or other additional light-modifying members.

The backlight system according to the present invention may, furthermore, advantageously be included in a display device, further comprising a selectively trans-missive image forming panel arranged to selectively allow passage of light from the backlight system to reach a viewer.

Such a trans-missive image forming panel may, for example, be a trans-missive or transflective liquid crystal panel.

### BRIEF DESCRIPTION OF THE DRAWINGS

These and other aspects of the present invention will now be described in more detail, with reference to the appended drawings showing currently preferred embodiments of the invention, wherein:

FIG. 1 is an exploded perspective view schematically illustrating a first embodiment of the backlight system according to the present invention;

FIG. 2 is a schematic section view of the outcoupling plate in the backlight system in FIG. 1;

FIG. 3 is a section view schematically illustrating a second embodiment of the backlight system according to the present invention; and

FIG. 4 is a block diagram schematically illustrating an exemplary control system for the backlight system according to the present invention.

### DETAILED DESCRIPTION OF PREFERRED EMBODIMENTS OF THE INVENTION

In the present description, the backlight system according to the present invention is described with reference to a backlight system having an outcoupling sheet, which is structured with prismatic indentations and two opposing outcoupling surfaces. Furthermore, the backlight system described herein has a backlight panel, which is equipped with a plurality of red (R), green (G) and blue (B) light-emitting diodes (LEDs). It should be noted that the present invention by no means is limited to the preferred embodiments described herein. For example, the outcoupling sheet may have any structure enabling outcoupling of a suitably small fraction of the light emitted by the light-sources provided on the backlight panel. Furthermore, the light-sources do not necessarily have to be LEDs, but may be any other suitable light-source conceivable to a skilled person. Such light-sources include, for example, fluorescent lamps, organic LEDs (OLEDs), plasma cells, and semiconductor lasers.

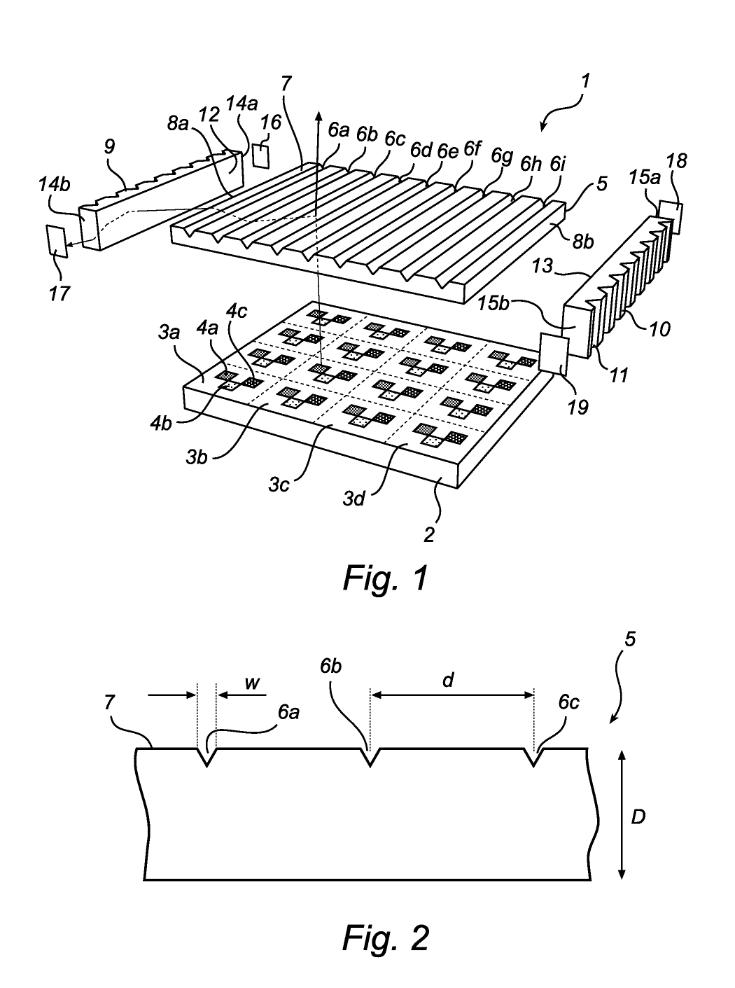

In FIG. 1, an exploded perspective view of a first embodiment of the backlight system according to the present invention is schematically shown.

With reference to FIG. 1, the backlight system 1 has a backlight panel 2, which supports a plurality of individually controllable light-sources, here in the form of RGB-clusters 3a-d each including at least one of each of red, green and blue LEDs 4a-c. For the sake of clarity of drawing, only a few of the depicted RGB-clusters and RBG-LEDs are indicated by reference numerals. The backlight panel 2 is preferably provided in the form of a printed circuit board (PCB), or the like, having conductive traces connecting the light-sources 3a-d to a power supply (not shown), preferably via control circuitry (not shown) for enabling individual control of the individually controllable light-sources 3a-d. Although not indicated in FIG. 1, the RBG-clusters 3a-d may include a larger number of RGB-sub clusters, which are controllable as a group. The LEDs 4a-c is preferably soldered to the backlight panel PCB 2, but may also be attached using a suitable conductive adhesive, an anisotropically conductive film, or the like.

On top of the backlight panel 2, an outcoupling plate 5 is arranged in the form of a thin, for example 1 to 3 mm, PMMA (poly-methyl methacrylate) or PC (poly-carbonate) plate which is provided with periodic outcoupling structures 6a-i in the form of prismatic indentations which are, for example, engraved on the top surface 7 (the surface facing away from the backlight panel 2) of the outcoupling plate 5. The structures 6a-i on the top surface 7 of the outcoupling plate 5 is described in more detail below with reference to FIG. 2. The outcoupling plate 5 has two opposing outcoupling surfaces 8a-b, adjacent to each of which a light guide 9, 10 is arranged to receive light emitted through the respective outcoupling surfaces 8a-b.

Each of the light-guides 9, 10 is provided with prismatic indentations 11, only one of which is indicated with a reference numeral. These prismatic indentations 11 are provided on the side of each light-guide 9, 10 facing away from the outcoupling-surfaces 8a-b of the outcoupling plate 5. In order to enable highly efficient guiding of light that is received by the light-guides at their respective incoupling surfaces 12, 13 towards the outcoupling surfaces 14a-b and 15a-b, the prismatic indentations are preferably provided with a short pitch of, for example, 0.1 to 0.3 mm.

Adjacent to each of the outcoupling surfaces 14a-b, 15a-b of the light-guides 9, 10, a sensor 16-19 is arranged to receive light that is outcoupled through the outcoupling surfaces 14a-b, 15a-b of the light-guides 9, 10. These sensors 16-19 are adapted to provide a signal indicative of at least one property of the outcoupled light. This signal is transmitted to a controller (not shown), which subsequently controls the individually controllable light-sources 3a-d in the backlight panel 2 to achieve the desired backlight system 1 properties.

Referring now to FIG. 2, illustrating an outcoupling plate 5 comprised in the backlight system 1 in FIG. 1, the outcoupling plate 5 has a thickness D, which is preferably 1 to 3 mm, but could be considerably thicker without detrimentally influencing the performance of the system. On the top surface 7 of the outcoupling plate 5, structures 6a-c are periodically provided having a width w and a pitch d. In order to transmit an as large as possible portion of the light emitted by the light-sources 3a-d in the backlight panel 2 through the outcoupling plate 5 towards a selectively trans-missive image forming panel (not shown), while ensuring that the outcoupled fraction of the emitted light is sufficiently large for the sensors 16-19 to give reliable readings, the size w of the structures 6a-d should preferably be 10 to 100 micron and the pitch d should preferably be 0.3 to 3 mm. A smaller size w and a larger pitch d yield a smaller outcoupling fraction.

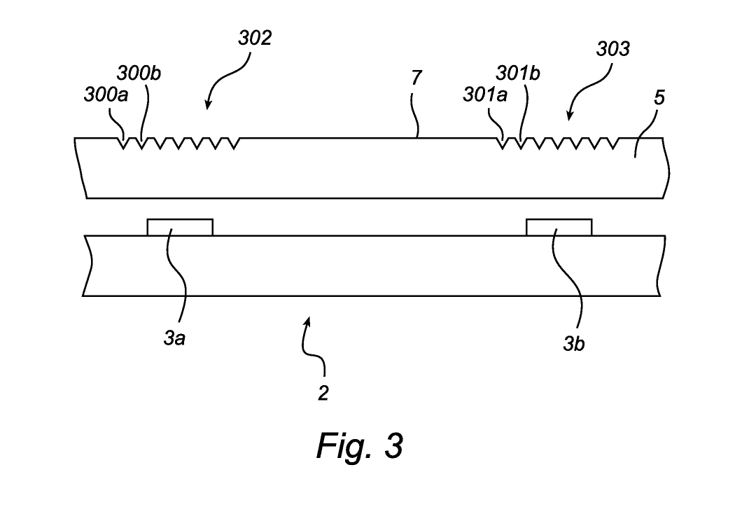

In FIG. 3, which is a section view of a portion of a second embodiment of the backlight system according to the present invention, two adjacent light-sources 3a-b are provided on the backlight panel 2. On the top surface 7 of the outcoupling plate 5, outcoupling structures 300a-b and 301a-b are provided (for clarity of drawing, only two of the structures in each group of outcoupling structures are indicated by reference numerals). The outcoupling structures 300a-b and 301a-b are provided in groups 302 and 303 which are centered above each of the light-sources 3a and 3b, respectively. Between the two groups 302 and 303, no outcoupling structures are provided. Through the outcoupling plate configuration according to FIG. 3, the normal operation of the backlight system is disturbed as little as possible while still capturing and outcoupling a sufficiently large fraction of the emitted light to be able to measure the individual output of each of the light-sources 3a-b. Although no outcoupling structures are indicated between the two groups 302 and 303 of densely arranged structures 300a-b, 301a-b in FIG. 3, outcoupling structures may, of course, be provided between the groups 302, 303. According to the present embodiment of the invention, these intermediate structures are then less densely arranged that the structures 300a-b, 301a-b in the groups 302, 303 provided on surface portions corresponding to the positions of the light-sources 3a-b on the backlight panel 2.

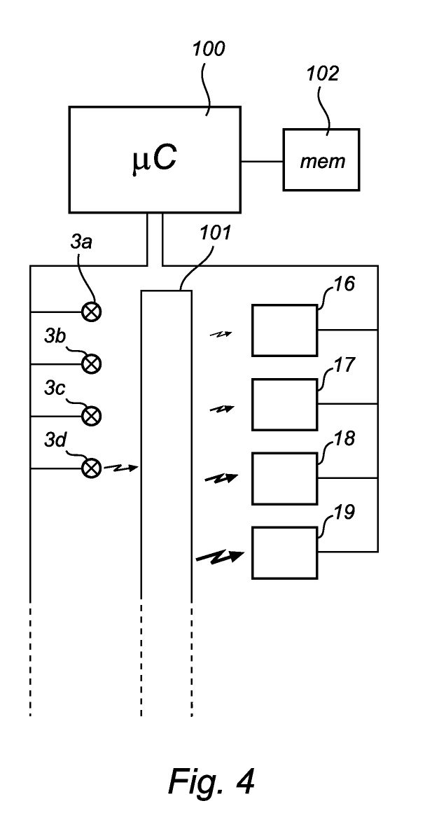

A typical calibration sequence will now be described with reference to FIGS. 1, 3 and 4. At calibration, control circuitry, here in the form of a microcontroller 100, controls each of the individually controllable light-sources 3a-d to emit light in sequence so that only one of the light-sources 3a-d emits light at one time. According to the example illustrated in FIG. 4, the light-source 3d emits (white) light as indicated by the arrow in FIG. 4. The light emitted by the selected light-source 3d is transmitted towards the sensors 16-19 by the optical system 101 constituted by the outcoupling plate 5 and the light-guides 9, 10. As is schematically indicated by the differently sized arrows in FIG. 4, the sensors 16-19 receive different amounts of the outcoupled fraction of the light emitted by the light-source 3d, due to the positioning of the particular light-source 3d.

The signals are added to a composite signal, which is evaluated by the micro-controller 100. The micro-controller 100 subsequently stores an updated set of calibration parameters for the light-source 3d in a non-volatile memory 102. Based on the stored sets of calibration parameters (one for each light-source), the micro-controller can control the light-sources 3a-d to emit light having desired properties, with respect to, for example, uniformity and/or color balance. The above-described calibration sequence can be carried out in the factory or after delivery of the device comprising the backlight system to the end-customer. In the latter case, calibration may preferably be carried out while switching on the device, at certain calibration intervals and/or during operation, given that the calibration is performed sufficiently rapidly. The person skilled in the art realizes that the present invention by no means is limited to the preferred embodiments. For example, primary color LEDs can be calibrated rather than white light RGB-clusters. Furthermore, the outcoupling plate may be structured in many other ways, such as with ridges or valleys that are not periodic and/or do not extend parallel to an outcoupling surface.

1. An adaptively controllable backlight system, comprising:
a plurality of individually controllable light-sources arranged on a backlight panel to emit light in a direction substantially normal to said backlight panel;
an outcoupling plate arranged adjacent to said backlight panel, and adapted to capture a fraction of the light emitted by said light-sources and to outcouple said fraction of light through at least one outcoupling-surface of said outcoupling plate;
at least one light-guide arranged to receive said outcoupled light and adapted to guide said outcoupled light towards at least one outcoupling-surface of said light-guide; and
at least one sensor arranged to receive said guided outcoupled light and adapted to provide a signal indicative of at least one property of said outcoupled light, thereby enabling adaptive control of said backlight system.

2. A backlight system according to claim 1, wherein structures are formed on a surface of said outcoupling plate facing away from said backlight panel, an average width (w) of said structures being substantially smaller than an average distance (d) between said structures, to thereby ensure that only a suitably small fraction of said emitted light is captured.

3. A backlight system according to claim 2, wherein said average distance between said structures is smaller on first surface portions of said outcoupling plate corresponding to positions of said light-sources than on second surface portions of said outcoupling plate corresponding to spaces between said light-sources.

4. A backlight system according to claim 3, wherein said average distance between said structures is equal for all of said first surface portions.

5. A backlight system according to claim 2, wherein said structures are periodically provided, a ratio between said width (w) and a period pitch (d) being smaller than 1/6.

6. A backlight system according to claim 1, wherein said outcoupling plate is adapted to outcouple light through two opposing outcoupling-surfaces.

7. A backlight system according to claim 1, wherein a corresponding one of said light-guides is positioned adjacent to each of said outcoupling-surfaces.

8. A backlight system according to claim 1, wherein at least one sensor is provided to receive guided light emitted through each of said light-guide outcoupling-surfaces.

9. A backlight system according to claim 1, further comprising at least one mirror arranged to direct light emitted through a corresponding light-guide outcoupling-surface to said at least one sensor.

10. A backlight system according to claim 1, further comprising control circuitry adapted to receive the signal provided by said at least one sensor, and to control said light-sources based on said received signal.

11. A backlight system according to claim 1, further comprising a light-spreading plate for spreading light emitted by said light-sources, thereby increasing uniformity of light emitted by said backlight system.

12. A backlight system according to claim 11, wherein said light-spreading plate is formed by said outcoupling plate.

13. A backlight system according to claim 1, further comprising a light-modifying member adapted to modify at least one property of outcoupled light interacting with said light-modifying member.

14. A backlight system according to claim 1, wherein said light-sources are semiconductor light sources, such as LEDs.

15. A display device comprising:
a backlight system according to claim 1; and
a selectively trans-missive image forming panel arranged to selectively allow passage of light from said backlight system to reach a viewer.
